(19) United States
(12) Patent Application Publication
(10) Pub. No.: US 2015/0281119 A1
(43) Pub. Date: Oct. 1, 2015

(54) METHODS AND SYSTEMS FOR TRANSFERRING AUTHORIZATION TO ACCESS MEDIA CONTENT BETWEEN MULTIPLE USER DEVICES

(71) Applicant: United Video Properties, Inc., Santa Clara, CA (US)

(72) Inventor: Lev Olkha, Los Angeles, CA (US)

(73) Assignee: UNITED VIDEO PROPERTIES, INC., Santa Clara, CA (US)

(21) Appl. No.: 14/226,233

(22) Filed: Mar. 26, 2014

(51) Int. Cl. H04L 12/927; H04L 29/08

(52) U.S. Cl. CPC H04L 47/80; H04L 67/10

(57) ABSTRACT

Methods and system are discussed herein for improvements for sharing authorizations to access media content between multiple user devices. Specifically, a media guidance application may facilitate automatic sharing of user authorizations between multiple user devices through the use of specially generated authorization data, which may be transferred between the multiple user devices using images.

### BACKGROUND

Conventional media delivery systems (e.g., cable, satellite, and Internet systems) provide users with a plethora of content. In some cases, the content may require a user receive authorization (e.g., from the provider) before accessing the content. For example, users may access content on-demand or through a subscription service by providing payment information and/or logging in to a user account. However, a typical user may have multiple user devices upon which the content can be accessed. Moreover, account log-ins are not available for all user devices and even for user devices that may be able to access an account, manually entering account information for each provider may be tedious.

### SUMMARY

Accordingly, methods and system are discussed herein for improvements for sharing authorizations to access media content between multiple user devices. Specifically, a media guidance application may facilitate automatic sharing of user authorizations between multiple user devices through the use of specially generated authorization data, which may be transferred between the multiple user devices using intuitive transfer mechanisms that relieve the user of the burden of manually entering payment information, retrieving confirmation codes, or logging in to one or more accounts.

For example, a media guidance application may authorize a user to access a media asset (e.g., a pay-per-view movie) on a first user device (e.g., a hotel room television) in return for a fee. The terms of the authorization may indicate that a user may access the media asset for a particular length of time, a particular number of times, etc. Additionally, the terms of the authorization may indicate that the user may access the media asset on additional user devices (e.g., a home television, a personal computer, a smartphone, and/or any other user device associated with the user). For example, in case a user cannot complete the viewing of the media asset before the user must leave the proximity of the first user device, the user may gain authorization to view the media asset on a second user device.

To facilitate the access of the media asset on additional user devices, the media guidance application may present authorization data, which may allow another user device to access the media asset. Moreover, the authorization data may be embedded or presented with the media asset such that a user may easily obtain the authorization data (e.g., by capturing an image of the media asset in which the authorization data is embedded into or presented with).

In some aspects, the media guidance application receives a first user request to access a media asset on a first user device. For example, the first user request may correspond to a user ordering or selecting the media asset from a list of available media assets in accordance with one or more authorization terms (e.g., a length of time that the media asset may be accessed, a number of times that the media asset may be accessed, a user authorized to access the media asset, an account authorized to access the media asset, a type of second user device that may access the media asset, etc.). The media guidance application may then authorize a user to access the media asset in accordance with one or more authorization terms. For example, the one or more authorization terms may correspond to terms indicated in the user request.

The media guidance application then retrieves the authorization data from a database of authorization data based on an identifier in the media asset, in which the authorization data authorizes the user to access the media asset on a second user device in accordance with the one or more authorization terms. For example, the media guidance application may generate authorization data that includes the authorization terms of the user access, the media asset to be accessed, and any other information that the media guidance application and/or one or more user devices may require. The media guidance application then generates for display the authorization data simultaneously with the media asset. For example, the authorization data may be embedded in the media asset such that while the authorization data may be detectable by a user device (e.g., a smartphone capturing an image or screenshot of the media asset with the embedded authorization data), the authorization data is not perceivable by a user (e.g., such that the presentation of the authorization data is distracting to the user).

In some embodiments, the media guidance application may notify the user that the authorization data is being presented or the authorization data may be perceivable by the user. For example, the authorization data may appear as an on-screen barcode (e.g., which may be decoded to indicate the one or more authorization terms).

In some embodiments, the media guidance application may receive an additional user request to generate for display the media asset on a second user device. For example, the media guidance application may receive a second user request to access the media asset on the second user device, in which the second user request includes an image (e.g., captured via a content capture component associated with the second user device) of the authorization data simultaneously displayed with the media asset on the first user device. The media guidance application may then cross-reference the image with the database of authorization data to determine the one or more authorization terms. For example, the authorization data may represent the encoded one or more authorization terms. To determine the one or more authorization terms, the media guidance application may decode the authorization data.

The media guidance application may then process the one or more authorization terms to determine whether the one or more authorization terms authorize the media asset to be accessed on the second user device. For example, the one or more authorization terms may indicate whether or not the user (or second user device) is granted access to the media asset. The media guidance application may then generate for display the media asset on the second user device in response to determining whether the one or more authorization terms authorize the media asset to be accessed on the second user device. For example, in response to determining that the user (or second user device) is authorized to access the media asset, the media guidance application may generate for display the media asset on the second user device and/or another user device selected by the user.

In some embodiments, the media guidance application may allow the user to access supplemental content associated with the media asset. For example, the media guidance application may generate for display cast and crew information, deleted scenes, or other additional content associated with the media asset on another device based on the authorization data. For example, the media guidance application may receive a second user request to access supplemental content associated with the media asset on a second user device, wherein the second user request includes an image of the authorization data simultaneously displayed with the media asset on the first user device. The media guidance application may then cross-reference the image with the database of authorization data to determine the one or more authorization terms.

The media guidance application may then process the one or more authorization terms to determine whether the one or more authorization terms authorize the supplemental content to be accessed on the second user device, and generate for display the media asset on the second user device in response to determining whether the one or more authorization terms authorize the supplemental content to be accessed on the second user device.

In some embodiments, the authorization data may be continually updated by the media guidance application. For example, the media guidance application may update the authorization data to indicate a playback position in the media asset that corresponds to the viewing progress of the user. As the user continues to view the media asset (i.e., as the playback position progresses), the media guidance application may update the authorization data to indicate this progress. Accordingly, if the media asset is displayed on a second user device, the media asset may be generated for display on a second user device at the current playback position of the user.

In some embodiments, the authorization data may be continually updated by the media guidance application based on the one or more authorization terms. For example, the media guidance application may determine access to the media asset on the second user device is no longer in accordance with the one or more authorization terms (e.g., the rental period associated with the media asset has expired), and the media guidance application may remove the authorization data from simultaneous display with the media asset in response to determining that access to the media asset on the second user device is no longer in accordance with the one or more authorization terms.

It should be noted, the systems and/or methods described above may be combined with, applied to, or used in accordance with, other systems, methods and/or apparatuses discussed both above and below.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance display including authorization data that is perceivable by a user in accordance with some embodiments of the disclosure;

FIG. 2 shows another illustrative example of a media guidance display for navigating and selecting media assets in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A is an illustrative example of a second user device capturing an image of authorization data generated for simultaneous display with a media asset in accordance with some embodiments of the disclosure;

FIG. 5B is an illustrative example of a second user device accessing a media asset based on authorization data in accordance with some embodiments of the disclosure;

FIG. 6 is a flowchart of illustrative steps for generating for display authorization data simultaneously with a media asset in accordance with some embodiments of the disclosure; and

FIG. 7 is a flowchart of illustrative steps for authorizing a second user device to access a media asset based on authorization data in accordance with some embodiments of the disclosure.

### DETAILED DESCRIPTION OF THE DRAWINGS

Methods and systems are discussed herein for improvements for sharing authorizations to access media content between multiple user devices. By facilitating automatic sharing of user authorizations between multiple user devices using intuitive transfer mechanisms, users are relieved of the burden of manually entering payment information, remembering passwords, retrieving confirmation codes, printing receipts, or logging in to one or more accounts. As used herein, “a media guidance application,” “interactive media guidance application,” or “guidance application” refer to a form of media guidance through an interface that allows users to efficiently navigate, identify, view, play back, and/or obtain information about content that they may desire.

In some embodiments, the media guidance application may be provided as an on-line application (i.e., provided on a website), or as a stand-alone application on a server, user device, etc. Various devices and platforms that may implement the media guidance application are described in more detail below. In some embodiments, the media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and nonvolatile computer memory or storage devices such as a hard disk, floppy disk, USB drive, DVD, CD, media card, register memory, processor caches, Random Access Memory (“RAM”), etc.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

Throughout this disclosure some embodiments discuss sharing a media asset, or sharing an authorization to access a media asset, on multiple devices. It should be noted that content (e.g., a media asset) generated for display on a first device may correspond to content (e.g., the same media asset) generated for display on a second device even though the content on each device is not identical (e.g., different formats, lengths, versions, compatibilities, etc.). For example, a media guidance application may generate for display authorization data with a high definition media asset (e.g., on a high definition television) that authorizes the user to access the high definition media asset (e.g., or one or more versions of the media asset, such as a standard definition version of the media asset) on a second user device (e.g., a smartphone).

Alternatively, in some embodiments, sharing a media asset, or sharing an authorization to access a media asset, on multiple devices may be related to a single copy of a media asset. For example, the media guidance application may authorize multiple devices to access a single copy of a media asset stored at a particular repository. In such cases, the media guidance application may authorize only a single device to access the copy of the media asset at one time. Alternatively or additionally, the media guidance application may create a copy of the particular copy of the media asset for simultaneous display on multiple devices.

In some embodiments, the media guidance application may alternatively or additionally allow users to access supplemental content associated with a media asset. As referred to herein, “supplemental content” is content related to the media asset that is not itself the media asset. For example, while a media asset may include multiple formats, lengths, versions, cuts, etc., supplemental content includes all other content related to the media asset such as advertisements (e.g., coupons, limited-time offers, etc.), add-ins or extra features (e.g., cast and crew information, trailers, interactive applications, games, descriptive information, media guidance data, etc.), other media assets related to the initial media asset (e.g., media assets related by content, genre, cast, etc.), etc.

In some embodiments, access to the media asset or supplemental content is determined according to one or more authorization terms. As referred to herein, an “authorization term” is any condition, criterion, or schedule, whether or not related to a particular contract, agreement, offer, or purchase, that sets limitations, or grants rights, regarding access to the media asset or supplemental content. For example, an authorization term may relate to a length of time that the media asset may be accessed, a number of times that the media asset may be accessed, a user authorized to access the media asset, an account authorized to access the media asset, a type of second user device that may access the media asset, etc.).

In some embodiments, one authorization term may be dependent on another authorization term. For example, an authorization term may indicate a length of time, or a particular modification of a determined length of time, to allow a user to access a media asset based on whether or not a user accesses the media asset on a particular user device, a number of times that a user accesses the particular the media asset, etc. For example, an authorization term (or authorization terms) may include that a user may access a media asset two times and/or for two weeks.

It should be noted that in embodiments discussed throughout this disclosure “a length of time” may be measured in any temporal unit (e.g., seconds, minutes, days, years, etc.). In addition, a length of time may include the length of time that is required for the performance of one or more events. For example, the length of time may relate to the length of time that a user takes to access the media asset, a length of time that a media asset is available at one or more storage locations, or the length of time necessary for a triggering event to occur (e.g., for a user to completely view the entire media asset).

In some embodiments, authorization data may correspond to user selections of terms. For example, the media guidance application may receive a first user request to access a media asset (e.g., a user request to order or select the media asset from a list of available media assets) on a first user device in accordance with one or more authorization terms (e.g., a length of time that the media asset may be accessed, a number of times that the media asset may be accessed, a user authorized to access the media asset, an account authorized to access the media asset, a type of second user device that may access the media asset, etc.). The media guidance application may then select authorization terms that authorize the user to access the media asset in accordance with the one or more authorization terms.

In some embodiments, one or more authorization terms may be included in authorization data. As referred to herein, “authorization data” is any data that indicates, includes, communicates, codifies, or represents one or more authorization terms or otherwise facilitates the sharing of authorization to access a media asset between multiple devices. For example, authorization data may indicate to a repository of media assets whether or not a user and/or user device is authorized to access a media asset based on one or more authorization terms. In some embodiments, a media guidance application may determine the authorization terms associated with the authorization data and compare the terms to status information (e.g., the current data, the number of times a user has already accessed the media asset, etc.) to determine whether or not authorization to the media asset corresponds to the authorization terms (e.g., a predetermined length of time or number of times to access the media asset).

In some embodiments, the media guidance application may generate authorization data that includes the authorization terms of the user access, the media asset to be accessed, and any other information that the media guidance application and/or one or more user devices may require. For example, the media guidance application may retrieve the authorization data from a database of authorization data based on an identifier in the media asset, in which the authorization data authorizes the user to access the media asset on a second user device in accordance with the one or more authorization terms. For example, in response to identifying a media asset, the authorization terms, and/or the account, device or user associated with the authorization, the media guidance application may determine appropriate authorization data.

It should be noted that while in some embodiments described herein authorization data is subject to a cross-reference with a database, embodiments in which the authorization data is not subject to a cross-reference with a database may also be used. For example, the authorization data received may be complete any may indicate the authorization terms without additional processing. In such cases, the authorization data (and/or the media guidance application) does not require access to a database.

As referred to herein, “a media identifier” may refer to any information used to distinguish a media asset from other media assets. For example, a media identifier may include, but is not limited to, a serial number, title, description, etc. The media guidance application may also receive user identifiers, user device identifiers, and/or account identifiers. For example, the one or more authorization terms may restrict (or grant) access to the media asset for particular users, devices, or accounts. In such cases, user identifiers, user device identifiers, or account identifiers, which refer to any information used to distinguish a user, device, or account from other users, devices, or accounts, respectively, may also be received (e.g., via user input) or determined automatically by the media guidance application.

It should be noted, that in some embodiments, user, device, and/or account identifiers may all identify a single entity. Therefore, embodiments related to the identification of a particular user may also be applied to the identification of a particular device and/or account and vice versa. For example, a device may be associated with a particular user or account. Likewise, an account may be associated with a particular user or device. For example, a user may be associated with a particular account such as a social network or other on-line account. The media guidance application may further retrieve a user and/or devices associated with the social network account from a user profile associated with the account.

As referred to herein, a “social network,” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by a social media provider may make content (e.g., status updates, microblog posts, images, graphic messages, etc.) associated with a first user accessible to a second user that is within the same social network as the first user.

In some embodiments, the authorization data may be continually updated by the media guidance application. For example, the media guidance application may update the authorization data to indicate a playback position in the media asset that corresponds to the viewing progress of the user. As the user continues to view the media asset (i.e., as the playback position progresses), the media guidance application may update the authorization data to indicate this progress. Accordingly, if the media asset is displayed on a second user device, the media asset may be generated for display on a second user device at the current playback position of the user.

In some embodiments, the authorization data may be continually updated by the media guidance application based on the one or more authorization terms. For example, the media guidance application may determine access to the media asset on the second user device is no longer in accordance with the one or more authorization terms (e.g., the rental period associated with the media asset has expired), and the media guidance application may remove the authorization data from simultaneous display with the media asset in response to determining that access to the media asset on the second user device is no longer in accordance with the one or more authorization terms.

Furthermore, in some embodiments, the media guidance application may update the authorization data based on subsequent user actions. For example, a user may receive additional or modified access to a media asset in response to paying an extra fee. In such cases, the media guidance application may adjust or modify the authorization data associated with and/or presented to the user. The modified authorization data may then be presented to a user (e.g., in a media asset). Alternatively or additionally, the authorization data (as modified) may be stored in an online account or profile associated with the user.

Upon determining the proper authorization data, the media guidance application may generate for display the authorization data simultaneously with the media asset. For example, the authorization data may be embedded in the media asset such that while the authorization data may be detectable by a user device (e.g., a smartphone capturing an image or screenshot of the media asset with the embedded authorization data), the authorization data is not perceivable by a user (e.g., such that the presentation of the authorization data is distracting to the user).

In some embodiments, the media guidance application may notify the user that the authorization data is being presented or the authorization data may be perceivable by the user. As used herein, “a notification” is any audio or video signal that alerts a user to the presence of authorization data. In some embodiments, authorization data may itself constitute a notification (e.g., if it appears on screen). For example, the authorization data may appear as an on-screen barcode (e.g., which may be decoded to indicate the one or more authorization terms).

For example, the media guidance application may generate for display authorization data that is perceivable to a user, even if the particular authorization terms associated with the authorization data are not perceivable (e.g., an on-screen barcode). As used herein, “a barcode” is an optical machine-readable representation of one or more authorization terms relating to the media asset with which the barcode is associated. Furthermore, barcodes as described herein may include barcodes representing data by varying the widths and spacings of parallel lines (e.g., one-dimensional barcodes) or barcodes representing data using rectangles, dots, hexagons and other geometric patterns (e.g., two dimensional barcodes).

Authorization data and/or barcodes representing authorization data may be encoded and decoded by the media guidance application to encode and decode the one or more authorization terms using various languages, symbologies, codes or other tests such as edge determination, minimum reflectance, symbol contrast, minimum edge contrast, modulation, defects, decodability, unused error correction, fixed pattern damage, grid non-uniformity, axial non-uniformity, etc.

Whether perceivable to a user or not, the media guidance application may generate for display authorization data that may be communicated to another device by the other device scanning or reading the authorization data and/or barcode representing the authorization data using the techniques and tests discussed above and/or comparing the readings to an encryption key and/or other standard. In some embodiments, scanning or reading the authorization data and/or barcode representing the authorization data may occur by capturing an image, screen shot, or other data associated with the media asset and/or authorization data.

For example, to facilitate the access of the media asset on additional user devices, the media guidance application may present authorization data, which may allow another user device to access the media asset. Moreover, the authorization data may be embedded or presented with the media asset such that a user may easily obtain the authorization data (e.g., by capturing an image of the media asset in which the authorization data is embedded or presented). The use of images to detect watermarks and/or fingerprint data in media assets is discussed in depth in Davis et al., U.S. Patent Publication No. 2012/0311623, published Dec. 6, 2012, which is hereby incorporated reference in its entirety.

For example, in some embodiments, the media guidance application may receive an additional user request to generate for display the media asset on a second user device. For example, the media guidance application may receive a second user request to access a media asset on a second user device, in which the second user request includes an image (e.g., captured via a content capture component associated with the second user device) of the authorization data simultaneously displayed with the media asset on a first user device. The media guidance application may then cross-reference the image with the database of authorization data (or the decoded data associated with the authorization data) to determine the one or more authorization terms. For example, the authorization data may represent the encoded one or more authorization terms. To determine the one or more authorization terms, the media guidance application may decode the authorization data.

The media guidance application may then process the one or more authorization terms to determine whether the one or more authorization terms authorize the media asset to be accessed on the second user device. For example the one or more authorization terms may indicate whether or not the user (or second user device) is granted access to the media asset. The media guidance application may then generate for display the media asset on the second user device in response to determining whether the one or more authorization terms authorize the media asset to be accessed on the second user device. For example, in response to determining that the user (or second user device) is authorized to access the media asset, the media guidance application may generate for display the media asset on the second user device and/or another user device selected by the user.

Additionally or alternatively, the media guidance application may allow the user to access supplemental content associated with the media asset. For example, the media guidance application may generate for display cast and crew information, deleted scenes, or other additional content associated with the media asset on another device based on the authorization data. For example, the media guidance application may receive a second user request to access supplemental content associated with the media asset on a second user device, wherein the second user request includes an image of the authorization data simultaneously displayed with the media asset on the first user device. The media guidance application may then cross-reference the image with the database of authorization data to determine the one or more authorization terms.

The media guidance application may then process the one or more authorization terms to determine whether the one or more authorization terms authorize the supplemental content to be accessed on the second user device, and generate for display the media asset on the second user device in response to determining whether the one or more authorization terms authorize the supplemental content to be accessed on the second user device.

In some embodiments, scanning or reading the authorization data and/or barcode representing the authorization data may occur by capturing an image, screen shot, or other data associated with the media asset and/or authorization data. Various user devices may be capable of such functionality. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections or data used in operating the guidance application, such as program information, guidance application settings, user preferences, or user profile information.

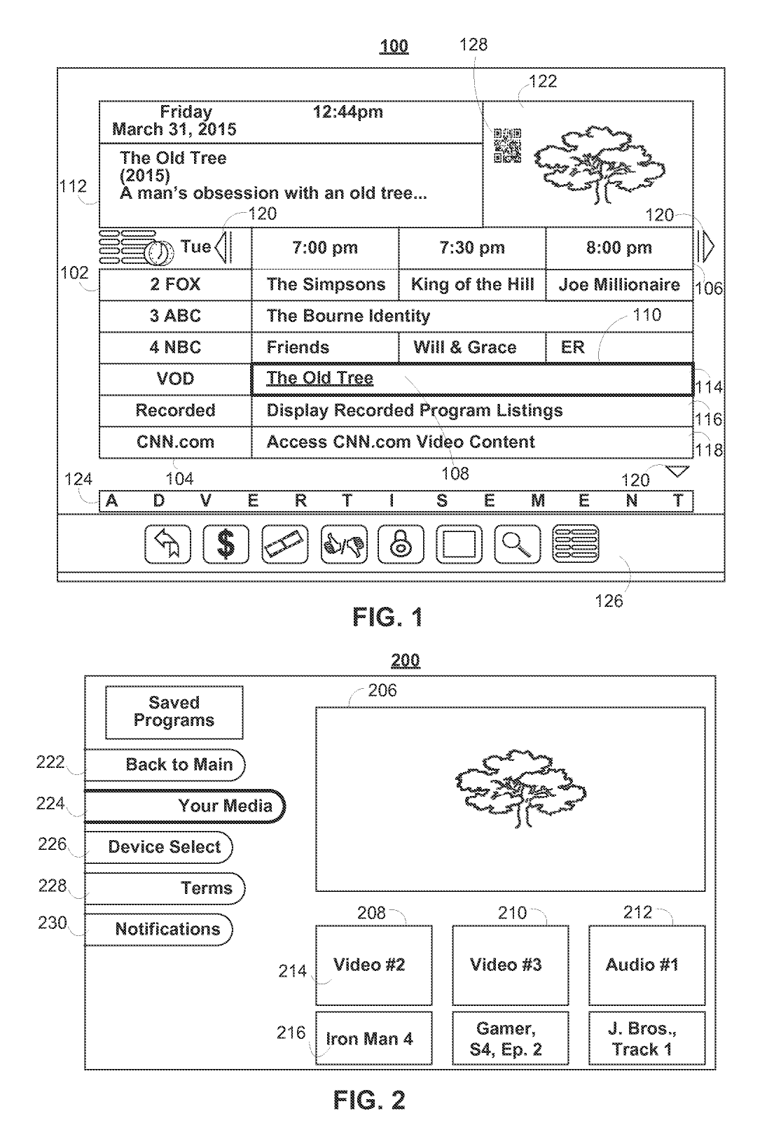

FIGS. 1-2 show illustrative display screens that may be used to provide media guidance data, media assets, and/or authorization data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid program listings display 100 arranged by time and channel that also enables access to different types of content in a single display. FIG. 1 also shows an illustrative example of a media guidance display including authorization data that is perceivable by a user. For example, authorization data 128, which corresponds to an on-screen barcode, appears generated for display with a media asset generated for display in video region 122. Authorization data is currently perceivable by a user; however, in some embodiments, authorization data may not be perceivable by a user. For example, authorization data 128 may be embedded into the media asset displayed in video region 122.

In some embodiments, authorization data 128 may be presented to a user in response to a user request for the authorization data. For example, in anticipation of stopping the presentation of a media asset or in anticipation of having to otherwise end the consumption of a media asset, a user may transmit a request to the media guidance application for authorization data. In response the media guidance application may generate for display on a display (e.g., display 100) authorization data (e.g., authorization data 128).

Display 100 also includes grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2, which shows another illustrative example of a media guidance display for navigating and selecting media assets. Video mosaic display 200 includes multiple selectable options. In display 200, selectable option 204 is selected, thus providing listings 206, 208, 210, and 212 as available programs for playback. For example, display 200 may represent a display associated with accessing media asset to which a user has authorization to access. For example, in some embodiments, listing 206 may appear in display 200 in response to a user (or a user device upon which display 200 is implemented) capturing an image of authorization data (e.g., authorization data 128 (FIG. 1)) associated with a media asset.

In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Display 200 also includes selectable option 222, which may direct a user to another display screen. Selectable option 226 may be associated with an option to select a one or more devices upon which to display a media asset associated with listing 206. For example, in some embodiments, the media guidance application may determine, based on authorization data associated with a user request, whether or not to authorize the user device from which the request was received to receive the media asset. Additionally or alternatively, the media guidance application may allow other devices to access the media asset in response to the request. For example, in response to the request, the media guidance application may authorize all devices associated with a user to access the media asset.

Display 200 also includes selectable option 228, which may show a user the authorization terms associated with listing 206. Additionally or alternatively, the media guidance application may receive user selections modify the authorization terms associated with a media asset via selectable option 228. For example, through selectable option 228, a user may order (or re-order) rights to access the media asset.

Display 200 also includes selectable option 230, which may allow a user to turn-on or turn-off or select a particular type, format, etc. for notifications related to authorization data. For example, via selectable option 230, a user may select whether or not authorization data is embedded with a media asset, presented as an on-screen barcode, or communicated to the user in another way.

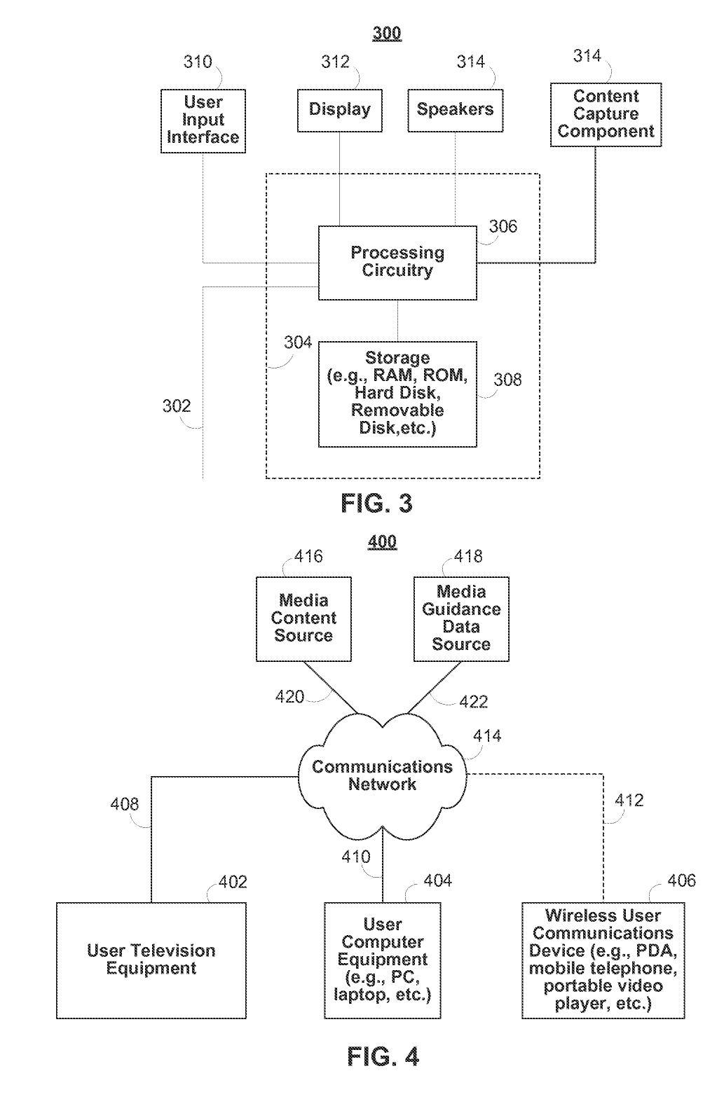

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data and guidance application data that are described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

Content capture component 316, or content capture component circuitry, may be incorporated into, coupled to, or accessible by the media guidance application (e.g., via control circuitry 304). Content capture component 316 may be used to capture an image, video, or other data associated with authorization data.

The guidance application may be implemented using any suitable architecture. For example, it may be a stand-alone application wholly implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network.

User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005, which is hereby incorporated by reference in its entirety. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

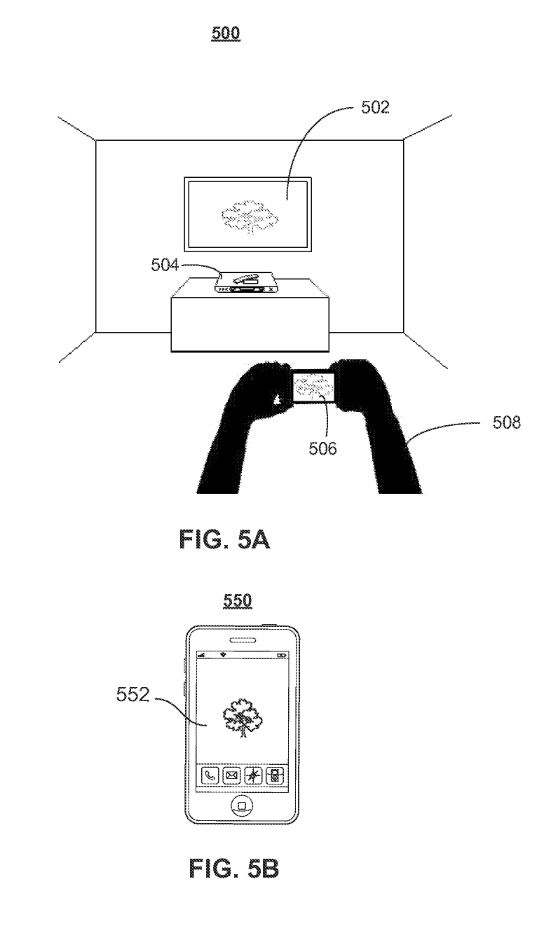

FIG. 5A is an illustrative example of a second user device capturing an image of authorization data generated for simultaneous display with a media asset. In viewing area 500, media asset 502 is currently being presented by a first user device 504. User 508 is currently capturing an image of media asset 502 using second user device 506.

A media guidance application (e.g., located on first user device 504, second user device 506, or on another device, such a remote server) may facilitate automatic sharing of user authorizations between first user device 504 and second user device 506. For example, by capturing content (e.g., an image) associated with media asset 502 with second user device 506, second user device 506 has also captured authorization data transmitted with media asset 502 (e.g., embedded into media asset 502). As user 508 is able to share authorization data associated with media asset 502 with second user device 506, user 508 is relieved from having to manually enter payment information, retrieve confirmation codes, or log in to one or more accounts in order to access media asset 502 on second user device 506. Furthermore, as discussed above in relation to FIG. 2, the authorization data captured with second user device 506 may be used to access media asset 502 on yet another device.

For example, a media guidance application may authorize a user to access a media asset (e.g., a pay-per-view movie) on first user device 504 (e.g., a hotel room television) after a user orders, rents, or otherwise gain access to media asset 502. The terms of the authorization may indicate that user 508 may access media asset 502 for a particular length of time, a particular number of times, etc. Additionally, the terms of the authorization may indicate that user 508 may access media asset 502 on additional user devices (e.g., second user device 506 and/or any other user device). To facilitate the access of media asset 502 on additional user devices (e.g., second user device 506), the media guidance application may present authorization data (e.g., authorization data 128 (FIG. 1)), which may allow another user device to access media asset 502.

As shown in FIG. 5A, authorization data is not currently perceivable to user 508. For example, the authorization data may be embedded in media asset 502. Nonetheless, user 508 may store the authorization data by capturing an image of the authorization data with second user device 506. In response to capturing the authorization data (e.g., authorization data 128 (FIG. 1)) on second user device 506, user 508 may access media asset 502 on a device other than first user device 504.

FIG. 5B is an illustrative example of a second user device accessing media asset 552 based on authorization data. For example, user device 550 may correspond to second user device 506 (FIG. 5A) or may correspond to yet another user device not shown in FIG. 5A (e.g., user equipment device 402, 404, or 406 (FIG. 4)) and media asset 552 may correspond to media asset 502 (FIG. 5A), listing 206 (FIG. 2), or the media asset displayed in video region 122. For example, in response to capturing an image containing the authorization data associated with media asset 502 (FIG. 5A)), a media guidance application (e.g., implemented on user device 550, media content source 416 (FIG. 4), and/or any location accessible via communications network 414 (FIG. 4)) may determine whether or not to authorize a user to access media asset 552.

In FIG. 5B, access to media asset 552 has been authorized (e.g., as shown by the playback of media asset 552 on user device 550). In some embodiments, a media guidance application may, in addition to authorizing user device 550 to access media asset 552, include other information related to the progress of media asset 552 on another device. For example, the authorization data used by user device 550 to access media asset 552 may additionally include information related to the progress or playback position of media asset 552 on another device. For example, if a user (e.g., user 508 (FIG. 5A)) captured an image of media asset 552 being presented on another user device (e.g., user device 504 (FIG. 5A)), the media guidance application might begin playback of media asset 552 at the point in media asset 552 at which the image was captured. For example, authorization data used to authorize user device 550 may also include state information associated with the media asset.

For example, if media asset 552 is a video game, authorization data may store the progress of the user in the video game such that when a user accesses the video game on user device 550, the state of the video game (e.g., the level, point total, etc.) associated with the video game when the authorization data was captured may be restored. Accordingly, the authorization data may be continually updated by the media guidance application. For example, the media guidance application may continuously or periodically update the authorization data to reflect the progress of a user in the media asset that corresponds to the viewing progress of the user.

Furthermore, in some embodiments, the authorization data may be continually or periodically updated by the media guidance application based on the one or more authorization terms. For example, the media guidance application may determine access to the media asset on the second user device is no longer in accordance with the one or more authorization terms (e.g., the rental period associated with the media asset has expired), and the media guidance application (e.g., via control circuitry 304 (FIG. 3)) may remove the authorization data from simultaneously displaying with the media asset (e.g., media asset 502 (FIG. 5A)) in response to determining that access to the media asset on the second user device is no longer in accordance with the one or more authorization terms.

In some embodiments, media asset 552 may be presented by a media guidance application on user device 550 after a user selects media asset 552 from available media assets. For example, the media guidance application may present a display screen (e.g., display 200 (FIG. 2)) that lists media assets that a user (e.g., user 508 (FIG. 5A)) is authorized to access. In response to the selection of a particular listing (e.g., listing 206 (FIG. 2)), the media guidance application may generate for display media asset 552.

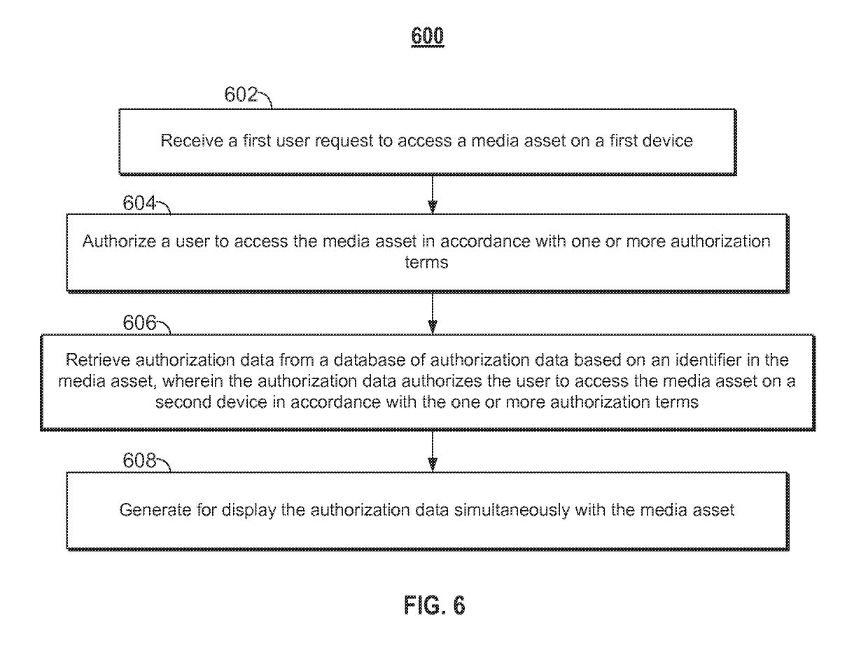

It should be noted that in some embodiments, media asset 552 may itself have authorization data generated for simultaneous display. For example, during playback of media asset 552 on user device 550, the media guidance application may generate authorization data (e.g., as described below in relation to FIG. 6)), which may authorize other devices to access media asset 552. More specifically, another user device may capture an image of media asset 552 on user device 550 and gain access to media asset 552 on that device. Accordingly, authorization to access media asset 552 may be shared between numerous devices in such a manner.

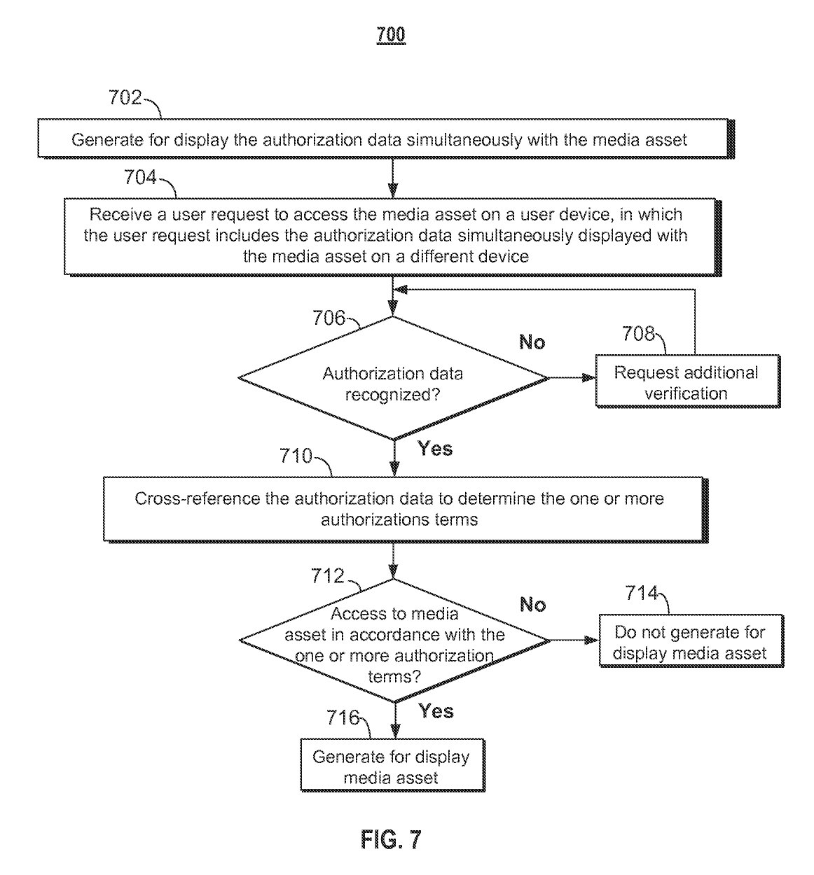

FIG. 6 is a flowchart of illustrative steps for generating for display authorization data simultaneously with a media asset. It should be noted that process 600 or any step thereof could be performed on, or provided by, any of the devices shown in FIGS. 3-4. For example, process 600 may be executed by control circuitry 304 (FIG. 3) as instructed by a media guidance application implemented on a user device (e.g., user equipment device 402, 404, and/or 406 (FIG. 4)) in order to determine whether to generate for display authorization data. In addition, one or more steps of process 600 may be incorporated into or combined with one or more steps of any other process or embodiment (e.g., process 700 (FIG. 7)).

At step 602, the media guidance application receives a user request to access a media asset on a first device. For example, the media guidance application may receive (e.g., via I/O path 302 (FIG. 3)) a request to access a media asset (e.g., media asset 502 (FIG. 5A)). Alternatively, the media guidance application may receive a request to access a media asset via input interface circuitry (e.g., incorporated into user input interface 310 (FIG. 3)) coupled to control circuitry (e.g., control circuitry 304 (FIG. 3)) implementing the media guidance application on a user device (e.g., user equipment device 402, 404, and/or 406, media content source 416, and/or any device accessible to communication network 414 (FIG. 4)).

In some embodiments, the request to access the media asset may include one or more terms that may correspond to authorization terms upon which authorization data is based. For example, a user may request to access a media asset for a particular length of time, a particular number of times, or on a particular number of devices. For example, in response to receiving a user request to rent a media asset for two weeks, the media guidance application (e.g., via control circuitry 304 (FIG. 3)) may establish a two-week length of time to access the media asset as an authorization term.

At step 604, the media guidance application (e.g., via control circuitry 304 (FIG. 3)) may authorize a user to access the media asset in accordance with one or more authorization terms. For example, in response to receiving the user request, the media guidance application (e.g., via control circuitry 304 (FIG. 3)) may authorize a user to access a media asset (e.g., media asset 502 (FIG. 5A)) on a user device (e.g., first user device 504 (FIG. 5A)) in accordance with the one or more authorization terms.

In some embodiments, the media guidance application (e.g., via control circuitry 304 (FIG. 3)) may authorize a user to access a media asset only after all authorization terms have been negotiated with, accepted by, and/or otherwise finalized with a user. Additionally or alternatively, access to a media asset may be granted only after the media guidance application confirms that payment or some other consideration has been received.

In some embodiments, the authorization terms may be dependent on the media asset. For example, in response to a user request to access a particular media asset, the media guidance application (e.g., via control circuitry 304 (FIG. 3)) may cross-reference a media identifier associated with the media asset in a database to determine the one or more authorization terms that are associated with accessing the media asset. For example, different media assets may be associated with different costs to access, lengths of time that the media asset may be accessed, etc. The media guidance application (e.g., via control circuitry 304 (FIG. 3)) may input the media identifier into a database of authorization terms to determine the particular authorization terms associated with a particular media asset. The media guidance application may then output the one or more authorization terms for acceptance by a user.

In some embodiments, the media guidance application (e.g., via control circuitry 304 (FIG. 3)) may allow the user to negotiate for particular authorization terms. For example, the media guidance application (e.g., via control circuitry 304 (FIG. 3)) may allow a user to customize the length of time a media asset is allowed to be accessed, the number of times a media asset may be accessed, the user devices upon which the media asset may be accessed, etc. For example, in response to an offer (e.g., entered by a user into user input interface 310 (FIG. 3)), the media guidance application (e.g., via control circuitry 304 (FIG. 3)) may process the offer and either accept, reject, or propose a counteroffer.

At step 606, the media guidance application (e.g., via control circuitry 304 (FIG. 3)) retrieves authorization data from a database of authorization data based on an identifier in the media asset, wherein the authorization data authorizes the user to access the media asset on a second device in accordance with the one or more authorization terms. For example, once the one or more authorization terms have been determined and/or accepted by the media guidance application and/or user, the media guidance application may generate authorization data for the media asset based on the one or more authorization terms.

For example, the media guidance application (e.g., via control circuitry 304 (FIG. 3)) may input the media identifier and the one or more authorization terms into a database (e.g., located locally at storage 308 (FIG. 3) or remotely at any location accessible via communications network 414 (FIG. 4)). The database may then cross-reference the inputs to determine authorization data that corresponds to the inputs. The database may then output authorization data that is representative of the inputs. For example, if the authorization terms indicate that a particular media asset (e.g., identified by a media asset identifier) may be accessed for one week by one or more user devices associated with the user, the authorization data, once decoded, may also indicate these terms.

At step 608, the media guidance application (e.g., via control circuitry 304 (FIG. 3)) generates for display the authorization data simultaneously with the media asset. For example, in response to determining the authorization data, the media guidance application (e.g., via control circuitry 304 (FIG. 3)) may generate for display the authorization (e.g., authorization data 128 (FIG. 1)) simultaneously with a media asset (e.g., media asset 502 (FIG. 5A)). In some embodiments, the authorization data may be embedded in the media asset (e.g., as discussed in relation to FIG. 5A)) such that while the authorization data may be detectable by a user device (e.g., second user device 506 (FIG. 5A)), the authorization data is not perceivable by a user (e.g., such that the presentation of the authorization data is distracting to the user). Alternatively or additionally, the authorization data may be perceivable to a user (e.g., as discussed in relation to FIG. 1)). In such cases, the authorization data or a notification related to the authorization data may appear as an on-screen icon (e.g., a barcode), graphic, textual message, and/or any other suitable object.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

FIG. 7 is a flowchart of illustrative steps for authorizing a second user device to access a media asset based on authorization data. It should be noted that process 700 or any step thereof could be performed on, or provided by, any of the devices shown in FIGS. 3-4. For example, process 700 may be executed by control circuitry 304 (FIG. 3) as instructed by a media guidance application implemented on a user device (e.g., user equipment device 402, 404, and/or 406 (FIG. 4)) in order to authorize a second user device to access a media asset based on authorization data. In addition, one or more steps of process 700 may be incorporated into or combined with one or more steps of any other process or embodiment (e.g., process 600 (FIG. 6)).

At step 702, the media guidance application (e.g., via control circuitry 304 (FIG. 3)) generates for display the authorization data simultaneous with the media asset. In some embodiments, step 702 may correspond to step 608 (FIG. 6). For example, the authorization data generated for simultaneously display with the media asset may correspond to authorization data generated by process 600 (FIG. 6)). As discussed above, the media guidance application (e.g., via control circuitry 304 (FIG. 3)) may generate for display the authorization (e.g., authorization data 128 (FIG. 1)) simultaneously with a media asset (e.g., media asset 502 (FIG. 5A)). In some embodiments, the authorization data may be embedded in the media asset (e.g., as discussed in relation to FIG. 5A)) such that while the authorization data may be detectable by a user device (e.g., second user device 506 (FIG. 5A)), the authorization data is not perceivable by a user. Alternatively or additionally, the authorization data may be perceivable to a user (e.g., as discuss in relation to FIG. 1)). In such cases, the authorization data or a notification related to the authorization data may appear as an on-screen icon (e.g., a barcode), graphic, textual message, and/or any other suitable object.

At step 704, the media guidance application receives (e.g., via user input interface 310 (FIG. 3)) a user request to access the media asset on a user device, in which the user request includes the authorization data simultaneously displayed with the media asset on a different device. For example, as discussed in relation to FIGS. 5A-B, a second user device may capture (e.g., via content capture component 316 (FIG. 3)) an image of authorization data (e.g., authorization data 128 (FIG. 1)) on another device (e.g., first user device 504 (FIG. 5A)). The authorization data captured in the image may be included with the user request.

At step 706, the media guidance application (e.g., via control circuitry 304 (FIG. 3)) determines whether or not the authorization data is recognized. For example, in response to receiving a user request, the media guidance application (e.g., via control circuitry 304 (FIG. 3)) first determines whether or not valid authorization data is included with the request. If so, the media guidance application proceeds to step 710. If not, the media guidance application proceeds to step 708, and requests additional information.

For example, as described above, the media guidance application (e.g., via control circuitry 304 (FIG. 3)) may employ various scanning and reading techniques. In some embodiments, authorization data may have been decoded by the content capture component (e.g., content capture component 316 (FIG. 3)) associated with the user device that captured an image of the authorization data. In such cases, the authorization data may be transmitted to the media guidance application in a format other than the format in which it was generated for simultaneous display with an associated media asset. However, in some embodiments, the media guidance application may receive the authorization data while still encoded (e.g., in the format in which it was generated for simultaneous display with an associated media asset). In such cases, the media guidance application (e.g., via control circuitry 304 (FIG. 3)) may decode the authorization data upon receiving the user request.

If the media guidance application determines (e.g., via control circuitry 304 (FIG. 3)) that the authorization data included in the user request corresponds to authorization data retrieved from local (e.g., storage 308 (FIG. 3)) or remote (e.g., any location accessible via communications network 414 (FIG. 4)) storage, the media guidance application determines (e.g., via control circuitry 304 (FIG. 3)) that the authorization data is valid. Accordingly, the media guidance application proceeds to step 710. If the media guidance application determines (e.g., via control circuitry 304 (FIG. 3)) that the authorization data included in the user request does not correspond to authorization data retrieved from local (e.g., storage 308 (FIG. 3)) or remote (e.g., any location accessible via communications network 414 (FIG. 4)) storage, the media guidance application determines (e.g., via control circuitry 304 (FIG. 3)) that the authorization data is not valid. If not, the media guidance application proceeds to step 708, and requests additional information.

In some embodiments, the media guidance application may request the user re-transmit the request or re-transmit the request in a different format (e.g., with a higher picture or transmission quality). Additionally or alternatively, the media guidance application may request a user provide other identifying information (e.g., an account or payment information) such that the system can authorize the user without the authorization data.

At step 710, the media guidance application (e.g., via control circuitry 304 (FIG. 3)) cross-references the authorization data to determine the one or more authorization terms. For example, the media guidance application may cross-reference the authorization data received in the user request with a database (e.g., located locally at storage 308 (FIG. 3) or remotely at any location accessible via communications network 414 (FIG. 4)) to determine the one or more authorization terms that are associated with the authorization data as well as the media asset associated with the authorization data. For example, the media guidance application (e.g., via control circuitry 304 (FIG. 3)) may retrieve (e.g., from storage 308 (FIG. 3) and/or any location accessible to communications network 414 (FIG. 4)) a key used to encode the one or more authorization terms in the authorization data for use in decoding the authorization data. After determining the one or more authorization terms associated with the authorization data as well as the media asset, the media guidance application proceeds to step 712.

At step 712, the media guidance application (e.g., via control circuitry 304 (FIG. 3)) determines whether or not access to the media asset is in accordance with the one or more authorization terms. For example, the media guidance application (e.g., via control circuitry 304 (FIG. 3)) may determine the authorization terms associated with the authorization data and compare the terms to status information (e.g., the current data, the number of times a user has already accessed the media asset, etc.) to determine whether or not authorization of the media asset corresponds to the authorization terms (e.g., a predetermined length of time or number of times to access the media asset).

For example, the media guidance application (e.g., located on user equipment device 402, 404, and/or 406, media content source 416, and/or at any location accessible via communications network 414 (FIG. 4)) may decode (or receive previously decoded information with the user request) the authorization data to determine the one or more authorization terms and/or the media asset to which the authorization data corresponds. The media guidance application may then retrieve (e.g., via control circuitry 304 (FIG. 3)) current status information such as the current time, previous user interactions that relate to the authorization terms (e.g., the number of times a user has already accessed a media asset), device identifiers (e.g., to determine whether or not a requesting device corresponds to a device upon which access to the media asset is authorized), etc. from clock or timer circuitry incorporated into or accessible by control circuitry 304 (FIG. 3) and/or a user profile associated with the user (e.g., stored locally at storage 308 (FIG. 3)) or remotely at any location accessible via communications network 414 (FIG. 4)).

Based on the comparison, the media guidance application (e.g., via control circuitry 304 (FIG. 3)) determines whether or not the current status information corresponds to the authorization terms. For example, if the authorization terms indicate that a user may only access the media asset four times, and the status information indicates the user has already accessed the media asset four times, the media guidance application (e.g., via control circuitry 304 (FIG. 3)) may deny authorization. Alternatively, if the authorization terms indicate that a user may only access the media asset four times, and the status information indicates the user has only accessed the media asset three times, the media guidance application (e.g., via control circuitry 304 (FIG. 3)) may grant authorization.

If the media guidance application (e.g., via control circuitry 304 (FIG. 3)) determines that access to the media asset is in accordance with the one or more authorization terms, the media guidance application generates for display the media asset at step 716. If the media guidance application determines that access to the media asset is not in accordance with the one or more authorization terms, the media guidance application does not generate for display the media asset at step 714.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 7.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for transferring authorization to access media content between multiple user devices, the method comprising:
receiving a first user request to access a media asset on a first user device;
authorizing a user to access the media asset in accordance with one or more authorization terms;
retrieving authorization data from a database of authorization data based on an identifier in the media asset, wherein the authorization data authorizes the user to access the media asset on a second user device in accordance with the one or more authorization terms; and
generating for display the authorization data simultaneously with the media asset.

2. The method of claim 1, wherein the authorization data is embedded into the media asset.

3. The method of claim 1, wherein the authorization data is represented as an on-screen barcode.

4. The method of claim 1, further comprising:
receiving a second user request to access the media asset on the second user device, wherein the second user request includes an image of the authorization data simultaneously displayed with the media asset on the first user device;
cross-referencing the image with the database of authorization data to determine the one or more authorization terms;
processing the one or more authorization terms to determine whether the one or more authorization terms authorize the media asset to be accessed on the second user device; and
in response to determining whether the one or more authorization terms authorize the media asset to be accessed on the second user device, generating for display the media asset on the second user device.

5. The method of claim 1, further comprising:
receiving a second user request to access supplemental content associated with the media asset on a second user device, wherein the second user request includes an image of the authorization data simultaneously displayed with the media asset on the first user device;
cross-referencing the image with the database of authorization data to determine the one or more authorization terms;
processing the one or more authorization terms to determine whether the one or more authorization terms authorize the supplemental content to be accessed on the second user device; and
in response to determining whether the one or more authorization terms authorize the supplemental content to be accessed on the second user device, generating for display the media asset on the second user device.

6. The method of claim 1, wherein the one or more authorization terms determine a length of time the media asset may be accessed, a number of times the media asset may be accessed, a user authorized to access the media asset, an account authorized to access the media asset, or a type of second user device that may access the media asset.

7. The method of claim 1, wherein the authorization data indicates a playback position of the media asset.

8. The method of claim 1, wherein the first user request indicates a selection of the one or more authorization terms.

9. The method of claim 1, wherein the authorization data is not perceivable by the user.

10. The method of claim 1, further comprising:
determining access to the media asset on the second user device is no longer in accordance with the one or more authorization terms; and
in response to determining that access to the media asset on the second user device is no longer in accordance with the one or more authorization terms, removing the authorization data from simultaneous display with the media asset.

11. A system for transferring authorization to access media content between multiple user devices, the system comprising:
storage circuitry configured to store a database of authorization data; and
control circuitry configured to:
receive a first user request to access a media asset on a first user device;
authorize a user to access the media asset in accordance with one or more authorization terms;
retrieve authorization data from the database of authorization data based on an identifier in the media asset, wherein the authorization data authorizes the user to access the media asset on a second user device in accordance with the one or more authorization terms; and
generate for display the authorization data simultaneously with the media asset.

12. The system of claim 11, wherein the authorization data is embedded into the media asset.

13. The system of claim 11, wherein the authorization data is represented as an on-screen barcode.

14. The system of claim 11, wherein the control circuitry is further configured to:
receive a second user request to access the media asset on the second user device, wherein the second user request includes an image of the authorization data simultaneously displayed with the media asset on the first user device;
cross-reference the image with the database of authorization data to determine the one or more authorization terms;
process the one or more authorization terms to determine whether the one or more authorization terms authorize the media asset to be accessed on the second user device; and
in response to determining whether the one or more authorization terms authorize the media asset to be accessed on the second user device, generate for display the media asset on the second user device.

15. The system of claim 11, wherein the control circuitry is further configured to:
receive a second user request to access supplemental content associated with the media asset on a second user device, wherein the second user request includes an image of the authorization data simultaneously displayed with the media asset on the first user device;
cross-reference the image with the database of authorization data to determine the one or more authorization terms;
process the one or more authorization terms to determine whether the one or more authorization terms authorize the supplemental content to be accessed on the second user device; and
in response to determining whether the one or more authorization terms authorize the supplemental content to be accessed on the second user device, generate for display the media asset on the second user device.

16. The system of claim 11, wherein the one or more authorization terms determine a length of time the media asset may be accessed, a number of times the media asset may be accessed, a user authorized to access the media asset, an account authorized to access the media asset, or a type of second user device that may access the media asset.

17. The system of claim 11, wherein the authorization data indicates a playback position of the media asset.

18. The system of claim 11, wherein the first user request indicates a selection of the one or more authorization terms.

19. The system of claim 11, wherein the authorization data is not perceivable by the user.

20. The system of claim 11, wherein the control circuitry is further configured to:
determine access to the media asset on the second user device is no longer in accordance with the one or more authorization terms; and
in response to determining that access to the media asset on the second user device is no longer in accordance with the one or more authorization terms, remove the authorization data from simultaneously display with the media asset.

21-50. (canceled)
